(19) United States
(12) Patent Application Publication
(10) Pub. No.: US 2016/0327409 A1
(43) Pub. Date: Nov. 10, 2016

(54) METHOD CHECKING THE ORIENTATION OF A MAGNETIC RING POSITION INDICATOR

(71) Applicant: Valeo Air Management UK Limited, Washford, Redditch Worcestershire (GB)

(72) Inventors: Kamel BOUALLAGA, Basildon Essex (GB); Dominique DUPUIS, Basildon Essex (GB)

(73) Assignee: VALEO AIR MANAGEMENT UK LIMITED, Washford, Redditch, Worecestershire (GB)

(21) Appl. No.: 15/108,438

(22) PCT Filed: Dec. 16, 2014
(86) PCT No.: PCT/GB2014/053712

§ 371 Date: Jun. 27, 2016

(30) Foreign Application Priority Data
Dec. 27, 2013 (GB) 1323078.4

(51) Int. Cl. G01D 5/14; H02P 25/08; H02K 29/08

(52) U.S. Cl. CPC G01D 5/145; H02K 29/08; H02P 25/08

(57) ABSTRACT

A magnetic indicator ring has a set of boundaries between magnetic domains. Some or all of these are to be identified. A reference set of measurements of the angular widths between the boundaries to be identified are measured and recorded. Later a second set of measurements of the widths between those boundaries are made and these widths are matched against the reference set. Matching up widths identifies which of the boundaries are which from the reference set. This enables other data recorded respective to those boundaries to be used. For example the other date may be offsets between the boundaries and the position of a rotor in a switched reluctance motor used to drive the compressor wheel in a supercharger.

### FIELD OF THE INVENTION

The present invention relates to the sensing of a magnetic ring indicator.

### BACKGROUND OF THE INVENTION

The control circuits of some motors, for example a switched reluctance motor, need to determine the position (i.e. orientation) of the rotor as it rotates so that the coils that drive the motor can be energised at appropriate time. The operation of a switched reluctance motor is described below to illustrate this point.

A typical switched reluctance motor is shown in FIGS. 1A, 1B and 2 to 4. This example has a combination (which is frequent) of six, preferably evenly, spaced poles 2 on the stator 1 and four, preferably evenly, spaced poles 3 on the rotor 4. In this example, the poles of the stator project inwardly from a stator ring 5, the ring providing a path of low reluctance material between the stator poles.

The rotor is formed of a stack of cross-shaped laminations, also of low reluctance material. Therefore each rotor pole is connected to the diametrically opposite rotor pole by a low reluctance path, for reasons which will become apparent. So, as marked, pole U is connected by a low reluctance path to pole U′ and pole V to pole V′.

Each pole of the stator is wound with a coil 6 and the coils are arranged in pairs, each pair comprising the coils at opposite ends of a respective diameter through the rotational axis of the motor. In this case therefore the pairs are coils AA′, BB′ and CC′, as marked. The coils of a pair are energised at the same time, with current from a motor control circuit 10 (FIG. 5), and in a sense such that one provides a magnetic field towards the rotational axis and one away from the axis. In the Figures the arrows on the coils represent the direction of the current in the coil above the plane of the paper and the dashed arrows represent the magnetic flux. Together the magnetic flux lines produced by the energised coils and their respective poles are arranged generally along the diameter between them and then follow the stator ring (in both circumferential directions) to the other energised coil of the pair.

The rotor modifies the distribution of magnetic field lines in the space between the energised pair of stator poles. Positions of the rotor in which a pair of diametrically opposite poles of the rotor are aligned along the diameter between the energised pair of stator poles are positions of the rotor that have minimum reluctance for the magnetic circuit that comprises the rotor between the aligned rotor poles, the energised stator poles and the stator ring. The example of rotor poles U and U′ being aligned between stator poles A and A′ is shown in FIG. 1B. Such a position is therefore a position of minimum magnetic energy. In a non-aligned position, e.g. as in FIG. 1A the magnetic flux still flows along the low reluctance path between the poles of rotor and so the flux is diverted from the diameter between the energised poles of the stator, with the result that it has to cross larger air gaps between the poles of the rotor and stator, increasing the reluctance of the magnetic circuit and the magnetic energy. So if the rotor is not aligned there is a torque on it drawing it towards the aligned position.

At operational rotation speeds the motor is driven by energising pairs of stator coils in turn to draw the poles of the rotor forward in the direction of rotation. So when, for example, the rotor is in the position of FIG. 1A and the rotor is rotating clockwise, so that rotor poles U and U′ are approaching stator poles A and A′, the coils of A and A′ are energised so that U and U′ are drawn towards A and A′. When the position of FIG. 1B is reached in which U and U′ are aligned with coils A and A′, A and A′ are turned off (FIG. 2) so that the rotor can continue to rotate without being slowed or drawn back to A and A′. At this point also rotor poles V and V′ are approaching stator poles of coils B and B′ so B and B′ are energised (FIG. 2) to draw stator poles V and V′ onwards in the clockwise direction towards B and B′.

When the position of FIG. 3 is reached in which V and V′ are aligned with coils B and B′, B and B′ are turned off so that the rotor can continue to rotate without being slowed or drawn back to B and B′. At this point rotor poles U′ and U are approaching the stator poles of coils C and C′ so coils C and C′ are energised to draw rotor poles U′ and U onwards in the clockwise direction towards C and C′.

When the position of FIG. 4 is reached in which U′ and U are aligned with C and C′ the coils C and C′ are turned off so that the rotor can continue to rotate without being slowed or drawn back to C and C′. At this point rotor poles V′ and V are approaching the stator poles of A and A′ so the coils A and A′ are energised to draw stator poles V′ and V onwards in the clockwise direction towards A and A′.

When V′ and V reach A and A′ the rotor has turned 90°, so, since the rotor has four fold rotational symmetry is in effect in the same position as FIG. 2 and so the cycle of energising coils B and B′ then C and C′ and then A and A′ is repeated to advance the rotor the next 90°, and so on.

As is known in the art the coils are switched off and on at particular angles of rotation of the rotor, for example in response to signals generated by Hall Effect sensors responding to the changing magnetic field provided by a magnetic ring mounted on the rotor shaft. FIG. 5 shows the motor with a magnetic sensor ring 50 mounted on the rotor shaft 51 of the motor 1 to rotate with the shaft and hence with the rotor. The sensor ring is located along the shaft at some distance from the rotor to avoid magnetic interference from the motor itself. (That distance is not apparent in the Figure since the view is along the axis of the shaft.) The ring is magnetised radially in eight sectors, with each being magnetised in the opposite direction. Three Hall Effect sensors 51, 53, 55 are mounted a short distance outside the ring 50 and to be stationary with respect to the stator. The sensors are distributed along a section of the circumference of the ring, spaced from each other in steps of 30° in the circumferential direction. This combination means that each N to S boundary of the ring (which are distinct to the sensors from the S to N boundaries) passes the three sensors in turn, one every 30° of rotation of the rotor and ring, and then after 90°, the next N-S boundary passes them in the same order again spaced by 30°, and so on. Each time an N-S boundary passes a sensor 51, 53, 55 its associated signal conditioning electronics produces, on a respective conductor, a respective pulse signal 52, 54, 56 at that time (FIG. 6).

A typical control circuit 10 for the motor is shown in FIG. 6. This comprises the stator coil pairs connected in parallel across a power supply 20. Coils A and A′, connected in parallel with each other, are energised by closing switches 21 and 22, and similarly coils B and B′ by switches 23 and 24 and coils C and C′ by switches 25 and 26. These switches are operated by the control circuit 10, which closes the switches when the coils are to be energised. Having the coils A and A′ operated by its common pair of switches 21 and 22 (similarly each coil pair B and B′, and C and C′, having its own pair of common switches) is sufficient to provide the patterns of coil energisation described above. The switches 21 to 26 are provided, for example, as FET or IGBT transistors. The position of the rotor is sensed by the Hall Effect sensors and is signalled to the control circuit 10, which uses the positions determined from the signal to determine the timings of the operation of the switches 21 to 26. Basically the switch controller 27 times the energisation of coil pairs AA′, BB′ and CC′ respectively in response to the pulses 52, 54, 56, respectively from the Hall Effect sensors 51, 53, 55. However, the control circuit 10 processes the signals 52, 54, 56, from the Hall Effect sensors in a number of other stages, forming a control loop.

These signals 52, 54, 56 are used as follows. The speed estimator 32 uses the time between the pulses to estimate the angular speed of the rotor to provide the rotor speed signal 33. The control loop is designed to control the speed of the motor to be as set by an input signal, speed command signal 35, and the difference between the speed command signal and the rotor speed signal is formed by a subtractor 36 to form a speed error signal 37. A loop controller, for example in this case a proportional-integral controller, uses this signal to adjust a torque command 39 for the motor. The relationship between the torque applied by a motor to its steady state speed is generally monotonically increasing. So the controller 38 increases the torque commanded if the speed error indicates that the motor is running slower than required and reduces torque commanded if the motor is running faster than commanded. The controller 38 also filters the signals circulating round the control loop in order to smooth the response of the loop.

The motor 1 is of course not controlled directly by a torque command and the torque command 39 is converted to control angles 42 for the switches of the motor. These angles are the angles of the rotor at which the switches of the motor operated, in particular the angles at which a coil pair is turned on, the angle at which it is allowed to “freewheel”, and the angle at which it is turned off. The switch controller 27 estimates the time to operate the switches from time of the relevant pulse 52, 54, or 56 and the angle 42 divided by the rotor speed signal 33.

To turn the pair of coils on both its associated switches are turned on (for coils AA′ switches 21 and 22). In the freewheel mode the switch (e.g. 21) connecting the coils to the positive supply is opened but the current continues to circulate through a diode and at the off angle both switches are opened and the current in the coil passes through the other marked diode marked to ground, dissipating over a short period after the switches are opened. (Alternatively, for the freewheel mode the switch connection the switch connecting the coils to the negative supply may be opened instead, with the current continuing to flow through the coils of the pair and the marked other diode. Which of the two switches is open in the freewheel mode can be alternated in order share balance the power dissipated by the switches between them.)

The conversion of the torque command signal to these angles is performed by a lookup table 41. The angles needed to provide the torque desired are dependent on the speed of the rotor, so the rotor speed signal 33 is also provided to the lookup table 41, to provide the angles for that torque and speed. These angles are determined empirically while driving the motor while connected to its desired load.

The angles 42 produced by the lookup table are passed (via offset angle corrector 43) to the switch control unit 27, which operates the switches at the corrected angles 42′ accordingly. In more detail, the switch controller 27 uses the pulses 52, 54, 56 on the respective conductors to time the switches for respective pairs of coils AA′, BB′, CC′. It calculates an offset in time for the operation of the switches from the angles 42′ supplied by the control loop and rotor speed signal. These angles 42′ are first adjusted by an angle offset corrector 43 from those 42 provided by the lookup table 41 to allow for the angular position of the N-S boundaries of the magnetic ring 50 with respect to the rotor. The offset adjustment needed (EOL (end-of-line) values 44) is measured at the end of manufacture of the motor complete with its magnetic indicator ring 50 in place on the rotor shaft, and is programmed into the motor control circuit 10. The offset is the difference between the angle at which a rotor pole passes a stator pole of a coil (A or B or C) and the angle at which the N-S boundary respective to that rotor pole passes the sensor 51, 53, 55 respective to that coil.

As is also known in the art, other combinations of stator and rotor pole numbers are possible for the motor. These have different cycles of energisation of the coils in order to keep the torque on the rotor in the forward direction. A common relationship between the numbers of poles is to have two more stator poles than rotor poles and to have both even in number. The choice of the number of poles usually takes into account the operating speed of the motor, the operating power, the acceptable level of torque ripple (variation in torque supplied by the motor with angle of the rotor), and the circuitry required.

In this example the indicator ring and a respective Hall Effect sensor provide an indication of the position of the rotor only every 90° and a whole cycle of operation of one of the coil pairs is determined by that indication. It therefore needs to be accurately positioned if the motor is to operate efficiently. However a problem is that it is difficult to make a magnetic ring with accurately positioned boundaries between its magnetic domains.

Note finally that it is usually generally preferred in such motors for reasons of balance of torque to energise coils in pairs that are diametrically opposite to each other.

### SUMMARY OF THE INVENTION

According to the present invention there is provided a method of identifying, for a magnetic ring indicator having a set of boundaries between sectors of different magnetisation, the boundaries of a plurality of the boundaries of the set, comprising

providing in a control circuit, for the plurality of the boundaries, a first plurality of measurements of the angular widths between the neighbouring ones of the boundaries of the plurality,

rotating the magnetic ring indicator so that a sensor indicates to the control circuit the occurrence of the boundaries of the plurality at the sensor,

the control circuit
calculating from the indicated occurrences of boundaries a second plurality of measurements of the angular widths between the neighbouring ones of the boundaries of the plurality, and
matching the angular widths of the first plurality to the angular widths of the second plurality to provide an indication of the match.

The plurality of boundaries may be all the boundaries between sectors of different magnetisation of the magnetic indicator ring.

The plurality of boundaries may be the boundaries between sectors of different magnetisation of the magnetic ring indicator that are of a particular type, which may be one of a north magnetisation to south magnetisation boundary or a south magnetisation to north magnetisation boundary.

The control circuit may calculate the angular widths from the times between the indicated occurrences of the boundaries.

The matching may be performed by the circuit performing, the following steps, one or more times:
selecting a new alignment offset between the provided angular widths and the calculated angular widths
comparing each of the provided angular widths respectively, according to the selected alignment offset, to the calculated angular widths,
until the control circuit determines that the results of the comparison meet a match criterion.

The match criterion may be that each calculated angular width is equal to the provided angular width to within a margin.

The provided angular widths may be measured during manufacture of a system including the control circuit and the magnetic indicator ring.

The method may further comprise in later operation:

a sensor indicating to the control circuit the occurrence of a boundary of the plurality being at the sensor,

the control circuit responding to that sensor indication to select, as indicated by the indication of the match, data recorded for that boundary.

The present invention also provides a method of operating a switched reluctance motor that comprises a rotor and a stator using the method of the invention, wherein the magnetic indicator ring is fixed to rotate with the rotor.

The present invention further provides a method of operating a switched reluctance motor that comprises a rotor and a stator using the method of the invention, further comprising in later operation:

a sensor indicating to the control circuit the occurrence of a boundary of the plurality being at the sensor,

the control circuit responding to that sensor indication to select, as indicated by the indication of the match, an offset angle recorded for that boundary, and using that offset angle to control the timing of the operation of a stator coil of the motor.

The method of the invention may be used with a switched reluctance motor that is coupled to drive a compressor wheel of a supercharger.

### BRIEF DESCRIPTION OF THE DRAWINGS

Examples of the invention will now be described with reference to the accompanying drawings, of which:

FIGS. 1-4 show consecutive stages of rotation of the rotor, or phases, in the operation of a known switched reluctance at operational speeds,

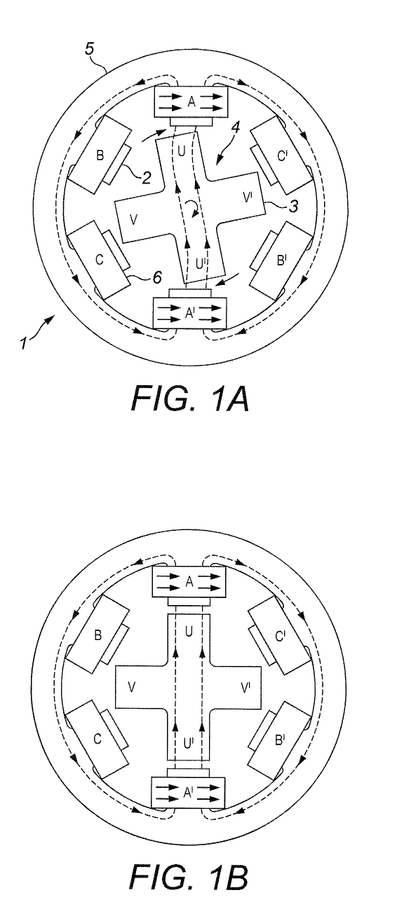

FIG. 5 shows a magnetic position indicator ring mounted on the motor of FIG. 1 etc. as used in both a second known control circuit for the motor of FIG. 1 etc. and in an example of a motor control circuit in accordance with the invention,

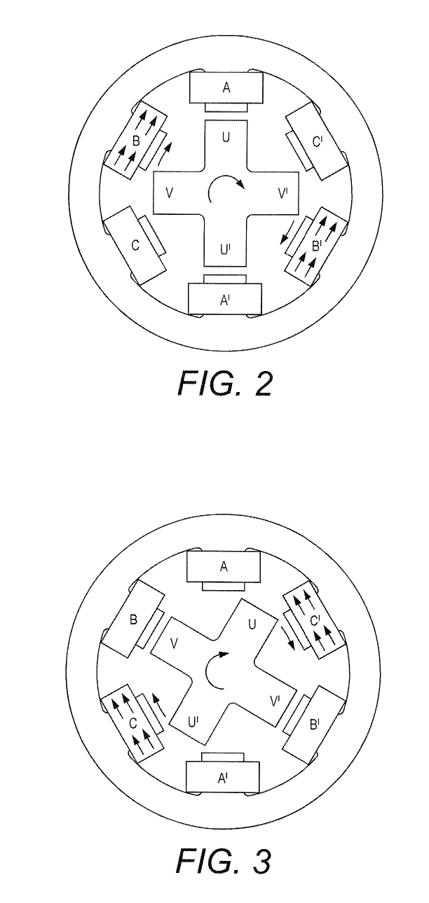

FIG. 6 is a block circuit diagram of a known control circuit for the motor of FIG. 1 etc.,

FIG. 7 shows ideal boundary positions around a magnetic indicator ring,

FIG. 8 shows an example of realistic boundary positions around the magnetic indicator ring,

FIGS. 9A and 9B are flow diagrams of methods of recording sector widths between N-S boundaries of the indicator ring at the end of manufacture,

FIG. 10 is a flow diagram of identifying the N-S boundaries during use in service, and

FIG. 11 is a detail of part of FIG. 10.

### EXAMPLES

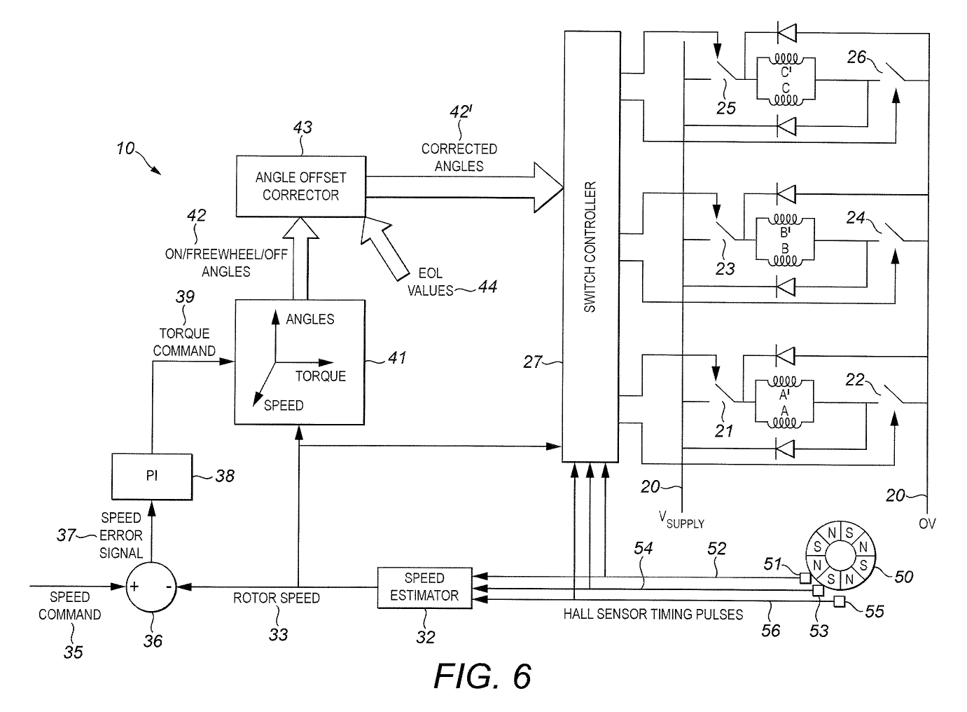

FIG. 7 shows the ideal boundary positions around magnetic indicator ring, which may be used in the motor control circuit described above. This ring has 8 poles (4 north and 4 south poles) spaced evenly and alternately so that the N-S domain boundaries (which are distinct to a Hall Effect sensor from S-N domain boundaries as the ring passes it in one particular direction) occur exactly every 90°. An eight pole ring is chosen to have the result that, ideally, each N-S boundary has the same angular offset to a respective one of the poles of a four pole rotor.

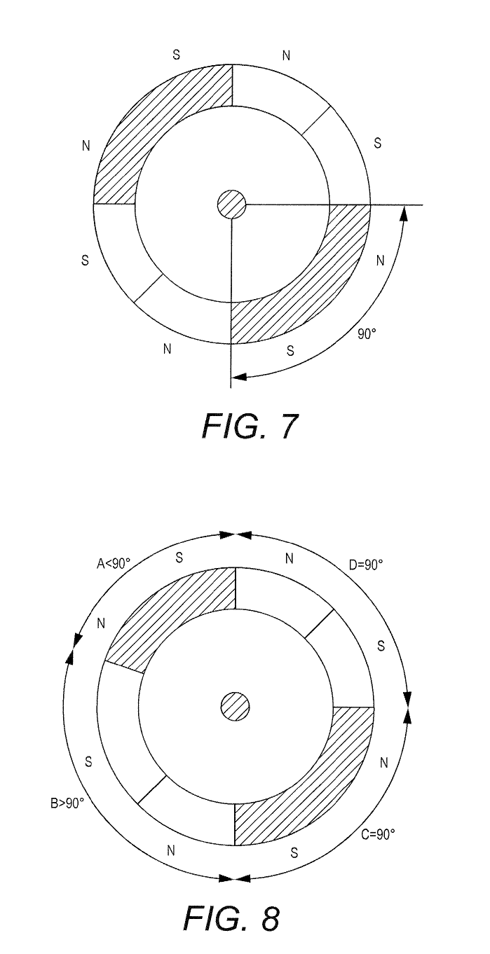

However manufacture of a magnetic ring with such accurately located magnetic domain boundaries is expensive. A more realistic distribution of the poles is shown in FIG. 8. This has some N-S domain boundaries separated by more than 90° and some by less than 90°. The Hall Effect sensors and the control circuit 10 described above assume however that the N-S boundaries are spaced by exactly 90°. This leads to timing errors in the turning off and on of the coils that energise that stator. However this can be allowed for by measuring the angular offset position of each N-S boundary during manufacture and then providing the control circuit with an individual angular offset for each N-S domain boundary (e.g. EOL values 44 described above). This however leads to another problem which is that when in use in service, the control circuit does not know which N-S boundary is which.

One method to address this problem would be to provide a second kind of reference mark, on the rotor/magnetic indicator ring, marking the position of one particular N-S boundary, which mark can then be sensed by the control circuit 10. The circuit could then keep of count of which N-S boundary is being sensed by a Hall Effect sensor. However this is added complexity, which of course increases cost and can reduce reliability.

The present invention, however, manages to address this problem using the existing Hall Effect sensors. (In fact only one of those is needed.)

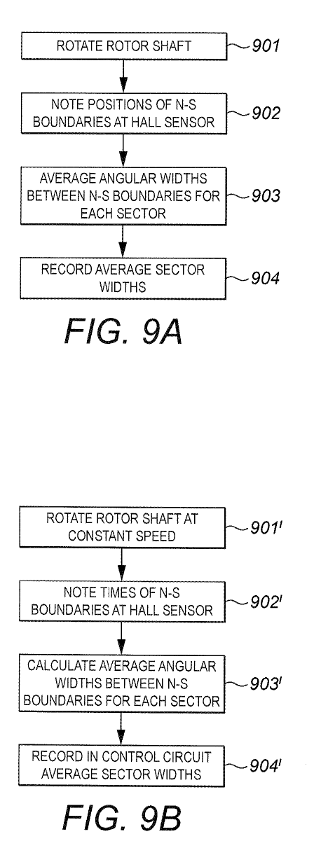

During manufacture the angular positions of the N-S boundaries are measured relative to each other. The procedure is shown in FIG. 9A.

In a first step (step 901) the rotor shaft, with the magnetic ring fixed in its final position is rotated. In a second step (902) one of the Hall Effect sensors is used to indicate the occurrence of the N-S boundaries and the angular position of the rotor as indicated by a shaft encoder coupled to the rotor is recorded. These are recorded for several rotations and then are used to calculate the angular widths of the sectors between the N-S boundaries. In a third step (903) the angles for each particular sector taken over several rotations are averaged to provide an average angle for each sector. In a final step (904), the average angular width of the sectors between N-S boundaries are recorded in the control circuit 10 for later use in service. The record indicates which of the sectors meet at which of the N-S boundaries, for example by the widths being in the order that they occur on the magnetic ring.

An alternative procedure is shown in FIG. 9B.

In a first step (step 901′) the rotor shaft, with the magnetic ring fixed in its final position is set to rotate at a constant angular speed. In a second step (902′) one of the Hall Effect sensors is used to indicate the times of the N-S boundaries. These are recorded for several rotations and then are used to calculate the angular widths of the sectors between the N-S boundaries. In a third step (903′) the angles for each particular sector taken over several rotations are averaged to provide an average angle for each sector. In a final step (904′), the average angular width of the sectors between N-S boundaries are recorded, in the control circuit 10 for later use in service. The record indicates which of the sectors meet at which of the N-S boundaries, for example by the widths being in the order that they occur on the magnetic ring.

(The identities of the N-S boundaries recorded with the widths are the same as, or can be related to, those of the N-S boundaries used when recording the individual N-S boundary offsets in the EOL values 44 used by the offset corrector 43.)

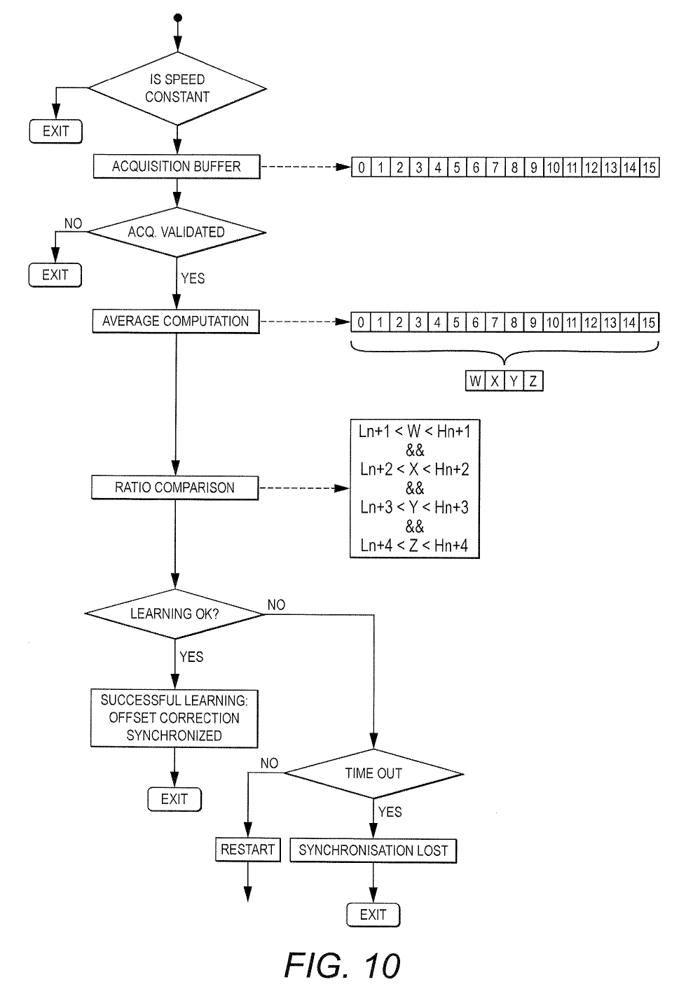

In service the control circuit 10 uses the average sector width information to identify which N-S boundary is which as they pass the Hall Effect sensors, so that the correct angular offsets can be applied by the control circuit as it operates the coil switches. The procedure is shown in FIG. 10.

In a first step the motor is set to be driven at a constant speed. (This driving is done assuming that the N-S boundaries are ideally spaced every 90°, but preferably using a measured offset between the overall angular position of the indicator ring with respect to the rotor, when controlling the times of operating the switches 21 to 26 to turn the stator coils on and off.)

In a second step over four rotations of the rotor, starting at some arbitrary N-S boundary passing a particular one of Hall Effect sensors, the times between N-S boundaries being indicated by that particular the Hall Effect sensor are recorded. (Only one of the Hall Effect sensors need be used in this step.) Since the motor rotation speed is constant these times are proportional to angular widths of the sectors between N-S boundaries.

In a third step these data are validated. For example it is checked that the sector widths are between +/−8° of specification.

In a fourth step the times for the same N-S boundary to N-S boundary sector from all four rotations are averaged to provide average times for all four sectors. These times are then converted into angles using the known speed of the motor.

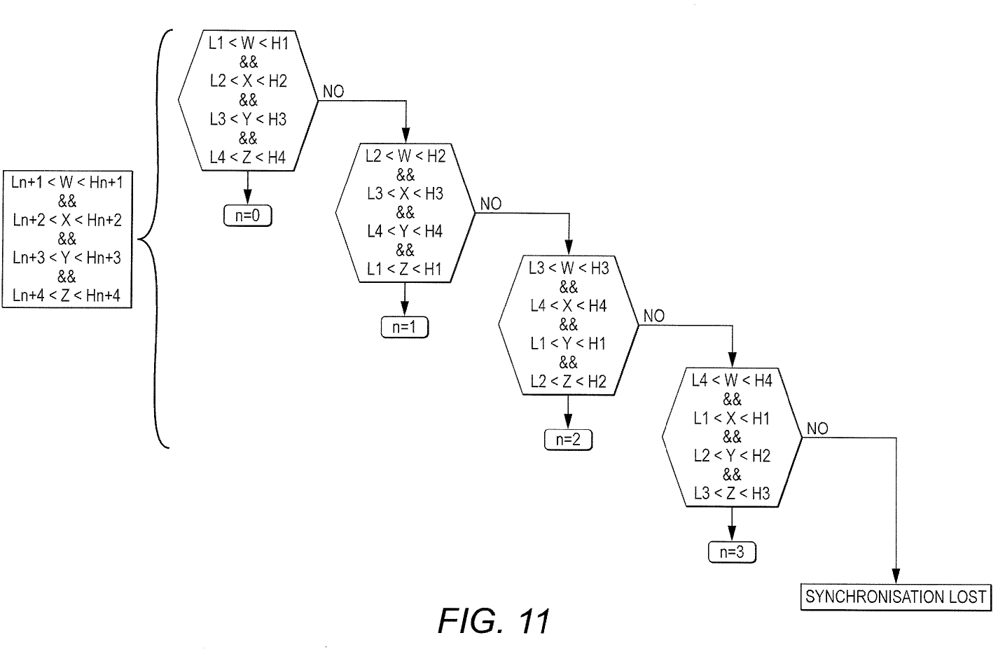

In a fifth step those widths are matched against those recorded for the same pattern of narrower and wider sectors. This is determined using the exemplary procedure shown in FIG. 11, which compares the average sector widths in the fourth step of the FIG. 10 procedure to the average sector widths recorded in control circuit 10 at the end of manufacture by the procedure of FIG. 9.

In a preparatory step (not shown) of the procedure of FIG. 11, a margin is set for the allowable difference between the two measurements of the magnetic sector widths. This can be a constant, or could be determined from the variation of the widths measured at the end of manufacture and/or in the FIG. 10 procedure. (Another possibility would be to make the margin to be the highest and lowest widths of a sector recorded at the end of manufacture.)

Then in a first step, a guess is taken that the first sector measured in the FIG. 10 procedure is the first sector for which the average width was recorded at the end of manufacture. To conclude that this is correct it is checked whether the those sectors match in width, to the accuracy of the margin, and whether each subsequent sector of the two sets match. (Thus in the decision hexagons in the Figure W, X, Y, and Z are the widths during service and Hᵢ and Lᵢ (where i is an index 1,2,3,4) are the widths measured during manufacture +/− respectively the margin.

If the first guess is not confirmed then in second, third and fourth steps, respective guesses are made that the second, third and fourth sector respectively measured in the FIG. 10 procedure is the first sector for which the average width was recorded at the end of manufacture and a similar check is made for each. So, in the second step, for example, the second sector width measure in the FIG. 10 procedure is compared to the first sector width recorded in the end of manufacture, the third with the second, the fourth with the third and the first with the fourth, and if all the comparisons fall within the margin then the second guess is confirmed, and the procedure finishes. The third and fourth steps are the same but the offset of the alignment between the members of the set of widths determined in the FIG. 10 procedure and the set of widths recorded in the end of manufacture procedure is increased by one each time.

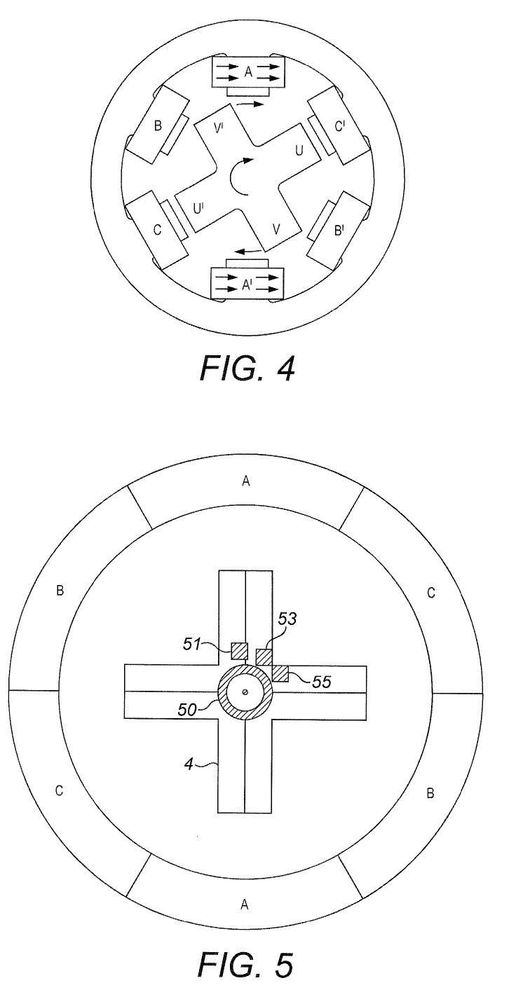

The procedures of FIGS. 10 and 11 are carried out by a microcontroller, forming part of the circuit of FIG. 6 under the control of a program. The microcontroller preferably performs other of the control and calculation steps of the circuit of FIG. 6.

This matching of the sectors allows the control circuit 10 to know which of the N-S boundaries is which. An indication of which alignment between the two sets is produced by the microcontroller and so the circuit has an indication of which N-S boundary is which and so can select the correct angular offset (from EOL values 44) to use when a particular N-S boundary is sensed by one of the Hall effect sensors 52, 54, 56.

Other methods of matching the two sets of widths may be used. For example, for each of the four possible alignments of widths between the sets, the ratio of the width from manufacture to that measured during is formed for each of the four sectors and the best alignment is selected as that for which the ratio is the most constant over the four sectors. (If the widths from manufacture and service are in the same units then that ratio should be approximately unity for all sectors for the aligned case.)

The invention is particularly suited to use in the switched reluctance motor of a supercharger, where the motor is coupled to drive the compressor wheel. This environment is hostile and needs simple robust sensors, such as the magnetic indicator ring.

1. A method of identifying, for a magnetic ring indicator having a set of boundaries between sectors of different magnetisation, the boundaries of a plurality of the boundaries of the set, comprising:
providing in a control circuit, for the plurality of the boundaries, a first plurality of measurements of the angular widths between the neighbouring ones of the boundaries of the plurality;
rotating the magnetic ring indicator so that a sensor indicates to the control circuit the occurrence of the boundaries of the plurality at the sensor;
the control circuit calculating from the indicated occurrences of boundaries a second plurality of measurements of the angular widths between the neighbouring ones of the boundaries of the plurality; and
matching the angular widths of the first plurality to the angular widths of the second plurality to provide an indication of the match.

2. The method as claimed in claim 1, wherein the plurality of boundaries is all the boundaries between sectors of different magnetisation of the magnetic indicator ring.

3. The method as claimed in claim 1, wherein the plurality of boundaries is the boundaries between sectors of different magnetisation of the magnetic ring indicator that are of a particular type.

4. The method as claimed in claim 3, wherein the particular type of boundary is one of a north magnetisation to south magnetisation boundary or a south magnetisation to north magnetisation boundary.

5. The method as claimed in claim 1, wherein the control circuit calculates the angular widths from the times between the indicated occurrences of the boundaries.

6. The method as claimed in claim 1, wherein the matching is performed by the circuit performing, the following steps, one or more times:
selecting a new alignment offset between the provided angular widths and the calculated angular widths, and
comparing each of the provided angular widths respectively, according to the selected alignment offset, to the calculated angular widths, until the control circuit determines that the results of the comparison meet a match criterion.

7. The method as claimed in claim 6, wherein the match criterion is that each calculated angular width is equal to the provided angular width to within a margin.

8. The method as claimed in claim 1, wherein the provided angular widths are measured during manufacture of a system including the control circuit and the magnetic indicator ring.

9. The method of claim 1, further comprising in later operation:
a sensor indicating to the control circuit the occurrence of a boundary of the plurality being at the sensor, and
the control circuit responding to that sensor indication to select, as indicated by the indication of the match, data recorded for that boundary.

10. A method of operating a switched reluctance motor that comprises a rotor and a stator using the method of claim 1, wherein the magnetic indicator ring is fixed to rotate with the rotor.

11. A method of operating a switched reluctance motor that comprises a rotor and a stator using the method of claim 10, further comprising in later operation:
a sensor indicating to the control circuit the occurrence of a boundary of the plurality being at the sensor, and
the control circuit responding to that sensor indication to select, as indicated by the indication of the match, an offset angle recorded for that boundary, and using that offset angle to control the timing of the operation of a stator coil of the motor.

12. The method as claimed in claim 10, wherein the switched reluctance motor is coupled to drive a compressor wheel of a supercharger.

13. (canceled)
